(19) United States
(12) Patent Application Publication
(10) Pub. No.: US 2011/0232124 A1
(43) Pub. Date: Sep. 29, 2011

(54) Heating media regenerators for high efficiency driers

(76) Inventor: Steve D. Shivvers, Prole, IA (US)

(21) Appl. No.: 12/001,891

(22) Filed: Dec. 13, 2007

Related U.S. Application Data
(60) Provisional application No. 60/899,964, filed on Feb. 7, 2007.

(51) Int. Cl. F26B 3/02; F26B 21/10

(52) U.S. Cl. 34/428; 34/86

(57) ABSTRACT

A drier apparatus for removing water from various materials includes a mixer, drying chamber, separator and regenerator and a method for use of the apparatus. The material to be dried is mixed with a heated media to form a mixture which then passes through the chamber. While passing through the chamber, a comparatively cool fluid is passed generally counter current through the mixture so that the mixture becomes cooler and drier and the fluid becomes hotter and more saturated with moisture. The mixture is then separated into drier material and media. The media is transferred to the regenerator and heated therein by the hot fluid from the chamber and supplemental heat is supplied to bring the media to a preselected temperature for mixing with incoming material to be dried. In a closed loop embodiment of the apparatus, the fluid exiting the regenerator is also recycled from the regenerator to the chamber and a chiller is utilized to reduce the temperature of the fluid to a preselected temperature and/or a preselected dew point temperature.

### CROSS REFERENCE TO RELATED APPLICATIONS

This application claims the benefit of U.S. Provisional application No. 60/834,125 filed Jul. 28, 2006 and U.S. Provisional application No. 60/899,964 filed Feb. 7, 2007 which are incorporated herein by reference.

### STATEMENT REGARDING UNITED STATES GOVERNMENT SPONSORED RESEARCH OR DEVELOPMENT

The present invention was at least in part made with support from the United States Government under Contract No. DE-FC36-01G011037 awarded by the Department of Energy and under Contract No. 2005-33610-15517 awarded by the USDA SBIR. The United States Government has certain rights in the invention.

### BACKGROUND OF THE INVENTION

The present invention is directed to improvements in driers and methods of drying used to dry various materials, including newly harvested grain, wood pellets, etc. and, in particular, to driers that recover and utilize a comparatively high percentage of the energy used in the drying process.

The drying industry is very large and utilizes significant amounts of both fossil fuels and electricity to dry various materials. While the grain industry is not the only industry that requires significant drying, it is indicative of the problems that exist. Just the U.S. corn crop amounts to almost nine billion bushels annually. Moisture must be removed in order to allow the grain to be stored without significant loss due to mold, mildew and rot caused by excess retained moisture.

In theory, each pound of water removed from the grain has a latent heat of vaporization of about 1160 British thermal units (Btu's) per pound. In a highly effective dryer system, the dryer could import exactly this theoretical amount of energy per pound of water to be removed from the grain. In reality, the grain also takes on sensible heat and raises in temperature during the process, the flow of heating gas is not uniform, the grain is often heated more on one side of the dryer than the other, etc., such that the efficiency of all types of conventional driers is comparatively low. Cross flow grain driers normally require approximately 2800 Btu per pound of water removed versus the theoretical amount of 1160 Btu per pound.

Because the corn industry in the U.S. consumes approximately 900 million gallons of propane and over 3200 million kilowatt-hours of electricity per year just to dry the corn and because this produces nearly two million tons of carbon dioxide exhaust gases per year, it is seen that any improvement in drying efficiency can amount to significant savings in fuel, energy and emissions. Corn is only one type of grain that must be dried. Further, there are many other solids, semi-solids and initially liquid compositions that are dried each year by vaporizing a liquid component or completely evaporating most or all of an incoming stream, at considerable costs in terms of fuel, energy and undesired emissions due to combustion of the fuels.

It is further noted that for some materials the manner of drying is important to prevent excessive shock to the product being dried and/or to reduce inconsistency in the dried material. For example, grain kernels can be cracked by cooling or heating too quickly, which can lead to degradation of the grain. While conventional driers may provide a chosen average moisture content, the content may not be consistent. Consequently, problems are encountered in many types of conventional cross flow grain driers where, the grain is heated and dried by air passing perpendicularly to the flow of the grain. In such driers, the grain on one side of the dryer that first encounters the heated air is overly dried and may be dried too quickly so as to cause cracking and the grain on the opposite or on the air discharge side tends to be too wet. Therefore, it is also desirable to provide a dryer that provides consistent, uniform and non stressful heating to drive off moisture and thereafter uniform and non stressful cooling.

In some circumstances, it is also desirable to provide a closed recycle system for gas used in the drying process to reduce dust or other undesirable emissions.

### SUMMARY OF THE INVENTION

A dryer wherein an incoming material, especially a granular, pelletized or other material, having removable moisture or other removable fluid therein that is to be removed by drying is generally uniformly mixed with a heated medium, in particular, a particulate medium, to form a mixture that is hotter than the incoming material to be dried and, thereafter, allowed to flow through a drying chamber from an entrance to an exit thereof. A cooling fluid, preferably air that is ambient or recycled, if exhaust emissions are of a concern, is counterflowed through the mixture from near the mixture exit to near the mixture entrance, such that the cooling fluid is heated by the mixture during passage through the chamber. As used herein the term cooling fluid refers to a drying fluid that absorbs and removes liquid, preferably mostly vapor produced by liquid to gaseous phase change, from a material to be dried. Sensible heat transfers from the heated media to the material to be dried and vaporizes the moisture or other liquid to be removed from the material, preferably by phase change. The fluid during passage through the chamber absorbs the moisture or vapor released from the material to be dried, so as to become fully saturated or, at least partly saturated as the fluid exists the chamber. In this manner, the fluid dries the material principally by phase change of the liquid that was originally contained in or on the incoming material to be dried. There is also normally cooling the material across a temperature gradient of cool to hot from near the material exit to near the material entrance.

At the chamber exit, the media (now comparatively cool) is separated from the material to be dried, by a separator, such as an air flow separator, a magnetic separator or especially a physical size separator such as a sizing screen that allows passage of one, but not the other. For this invention, the media can be larger or smaller than the material to be dried, when a screen is used. Other separation techniques are foreseen possible, especially where the components of the mixture are of the same size.

The material which at the discharge of the separator is comparatively drier than before entering the drier is then transferred to storage or the like. The media, which at the discharge preferably has been cooled by passage through the chamber, is then transferred back to the entrance to be mixed with the incoming material to be dried. During the transfer, the fluid which is heated and at least partially saturated with moisture subsequent to exiting the chamber is counter flowed past the media in a regenerator, so that the media is at least partially reheated. This allows the recovery of both sensible and latent heat from the fluid by the media.

Because the media is relatively cool and the fluid is hot and at least partly saturated with moisture or other condensible liquid, as the fluid cools during the media heating process, moisture or other liquid condensate forms on the media that is collected and withdrawn. In some instances, a blow off system is applied to the heated media wherein recycled process air or another gas is blown past the media after heating by the fluid to remove condensate adhering to the media. Prior to mixing with the incoming material to be dried, the partially heated media is passed through a makeup or supplemental heater that further heats the media to a preselected temperature that is determined to be best for mixing with the incoming material to be dried.

In certain embodiments, the various fluid streams are collected, especially the gas that exits the regenerator, is collected and returned to the drying chamber for recycle or repassing through the mixture therein. Because the fluid that is recycled in this manner will be somewhat hotter and contain more moisture than the fluid at the beginning of the process initially (for example, ambient air), an intermediate chiller may be utilized to cool the fluid to a preselected temperature and condense additional moisture from the fluid before flowing into the mixture in the chamber, so that condensate is removed from the process at the chiller. In this manner, the fluid is not exhausted to the atmosphere, so as to reduce dust or other undesirable emissions.

The media may be any suitable material that can function to become heated and convey such heat to the material to be dried. Such media could include rocks, ceramic or glass balls or other shapes, pieces formed of metal or the like. Preferably, the media is stable and not significantly damaged by recycle usage. When used with foodstuffs, such as grain, the media must be food safe.

Therefore, the basic process in general is to mix a material to be dried with a media that is preheated with recovered or reclaimed sensible and latent heat to form a mixture and allow that mixture to pass in a first direction through a chamber. A comparatively cool fluid, especially a gas such as air, is counter flowed in the opposite direction through the mixture in the chamber so that the material is first heated by the media and then cooled or the energy state is changed by latent heat release associated with the phase change of the liquid to be removed while being dried by the fluid. The comparatively cool dry media and dry material are separated. The heated and moisture carrying fluid is then counter flowed past the separated media and condensate is removed, so that the media is at least partly reheated. The partially heated media is then further heated by a makeup heater and returned to the incoming material to be dried to form the mixture therewith. The process, therefore, first heats the material to be dried and then dries the material by flowing cooling and drying fluid (generally referred to as cooling fluid herein) therethrough. The incoming comparatively cool and dry fluid becomes heated and removes moisture vaporized or evaporated from the material to be dried as the fluid passes through the chamber. Much of the sensible and latent heat utilized to drive moisture from the material is recovered and reused by this overall process and especially by the reheating of the media by the fluid exiting the chamber, thereby requiring comparatively little supplemental heat input into the media after being heated by the hot fluid.

While principally counter current flow processes are described above and preferred, both with respect to the drying of the material and the reheating of the media, it is foreseen that some processes may be at least partially counter flow, cross-flow, concurrent flow or mixtures thereof. Further the processes may have individual sections that are cross flow, counter flow, concurrent flow or mixtures of such flow, but which are overall counter current flow. The process could also be conducted in sequential steps wherein a certain amount of moisture is removed in each step, including wherein there are multiple drying chambers that each reduce moisture a given amount in sequence wherein the cooling fluid from all the chambers uses a single regenerator.

### OBJECTS AND ADVANTAGES OF THE INVENTION

Therefore, the objects of the invention are: to provide a dryer that is especially effective in drying material with comparatively smaller outside energy input; to provide such a dryer that is effective in uniformly and consistently drying materials; to provide such a dryer using a heated media to heat the material to be dried and wherein the media is at least partially reheated in a regenerator by heat removed during the drying process; and to provide such a drier that is easy to use, economical to build and operate and especially well adapted for the intended purpose thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a partially schematic view of a drier in accordance with the present invention having a vertical drying chamber.

FIG. 1A is a drier similar to that of FIG. 1 having a fluid recycle system and a fluid chiller.

FIG. 2 is a partially schematic view of a first modified drier in accordance with the present invention having a fluidized bed drying chamber.

FIG. 2A is a drier similar to the drier of FIG. 2 having a fluid recycle system and a fluid chiller.

FIG. 3 is a partially schematic view of a second modified drier in accordance with the present invention having a rotary drum drying chamber.

FIG. 3A is a drier similar to the drier of FIG. 3 having a fluid recycle system and a fluid chiller.

FIG. 4 is a partially schematic view of a third modified drier in accordance with the present invention having a vertical drying chamber and a cross flow media supplemental heater.

FIG. 4A is a drier similar to the drier of FIG. 4 having a fluid recycle system and a fluid chiller.

FIG. 5 is a partially schematic view of a fourth modified drier in accordance with the present invention including a fluidized bed drying chamber and a cross flow media supplemental heater.

FIG. 5A is a drier similar to the drier of FIG. 5 including fluid recycle and a fluid chiller.

FIG. 6 is a partially schematic view of a fifth modified drier in accordance with the invention showing a rotary drum drying chamber and a cross flow media supplemental heater.

FIG. 6A is a drier similar to the drier of FIG. 6 including fluid recycle and a fluid chiller.

FIG. 7 is a schematic and side elevational view of an alternative media regenerator in accordance with the invention.

FIG. 8 is a schematic and side elevational view of a second alternative media regenerator in accordance with the invention.

FIG. 9 is a schematic and side elevational view of a third alternative media regenerator in accordance with the invention.

FIG. 10 is a perspective view of a fourth alternative vibratory spiral elevator regenerator in accordance with the present invention.

FIG. 11 is a partially schematic cross sectional view of the regenerator of FIG. 10, taken along the line 11-11 of FIG. 10.

FIG. 12 is a schematic and side elevation view of a fifth alternative regenerator in accordance with the present invention.

FIG. 13 is a schematic diagram of a further alternative drying chamber wherein a mixture to be dried enters one end of the chamber and a cooling fluid flows generally overall counterflow to the mixture, but in stages flows concurrently with the mixture.

FIG. 14 is a schematic diagram of a still further alternative drying chamber wherein a mixture to be dried enters one end of the chamber and a cooling fluid flows generally overall counterflow to the mixture, but in stages flows cross flow relative to the mixture.

FIG. 15 is a schematic diagram of a yet further alternative drying chamber wherein a mixture to be dried enters one end of the chamber and cooling fluid flows generally overall counterflow to the mixture, but in stages the cooling fluid flows in mixed flow patterns relative to the mixture.

FIG. 16 is a schematic of a further alternative regenerator wherein media to be heated enters from one end and comparatively hot fluid flows overall generally counterflow to the media, but in stages the fluid flows concurrently with the media.

FIG. 17 is a schematic of a still further alternative regenerator wherein media to be heated enters from one end and comparatively hot fluid flows generally overall counter currently to the media, but in stages the fluid flows in cross flow through the media.

FIG. 18 is a schematic of a yet further alternative regenerator wherein media to be heated enters from one end and comparatively hot fluid flows generally overall counter current to the media, but in stages fluid flows in mixed flow patterns relative to the media.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

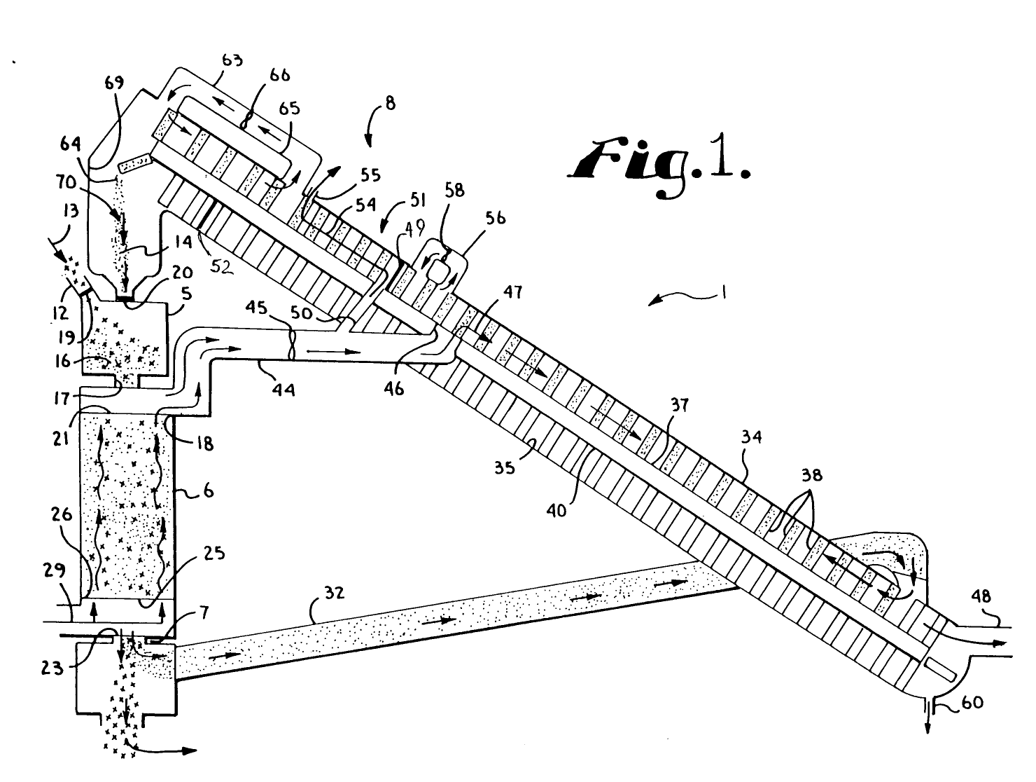

As shown in FIG. 1, the reference numeral 1 generally represents a drier in accordance with the present invention.

The drier comprises an inlet mixer 5 (that also functions to provide a heating zone or sweatbox), a drying chamber 6, a separator 7 and a regenerator system 8.

A material 12 to be dried (here corn) is fed at the arrow numbered 13 into the mixer 5 from a source outside the drier 1. At the same time a media 14 (here smooth rock of approximately one half inch diameter and larger) that has been heated is also fed into the mixer 5 and the media 14 and material 12 are subsequently mixed by flow into the mixer 5 and/or by use of an alternative agitator to form a generally uniform mixture 16 of material 12 and media 14. In the present embodiment, the mixture 16 has enough residence time in the mixer 5 to preferably approach thermal equilibrium at a common temperature. The heat transfer process in the mixer 5 will also preferably cause the material 12 to start to give off moisture or sweat in response to being heated by the media 14.

The mixture 16 discharges through a lower opening 17 into a top 18 of the chamber 6. Airlocks 19 and 20 are provided whereat the material 12 and media 14 enter the mixer 5. The chamber 6 can be round, square, rectangle, or other shapes and herein is approximately square in cross section and is preferably insulated to reduce heat loss. It is foreseen that in some embodiments the chamber 6 may be wider than thick or may be a modified conventional round grain bin. The chamber 6 includes a fluid collection manifold 21 that is perforated to allow the fluid to flow into the manifold 21 after passage through the chamber 6.

The chamber 6 of the illustrated embodiment is vertically higher or taller than wide and is joined at the bottom to a separator 7 that includes a screen 23 that effectively separates the cool and dry media 14 at the bottom of the chamber 6 from the material 12. The separated material 12 exits the drier 1 relatively cool and comparatively drier than when the material 12 entered the chamber 6. When drying most materials that absorb liquids, it is preferably that the fluid be a gaseous fluid, typically air, but other types of fluids are also effective, especially nitrogen where there is a high explosive risk, in the presence of oxygen, provided that such fluids permit the absorption and condensation of water vapor or other substance to be dried from the material 12. A fluid dispenser manifold 25 extends across the lower end 26 of the chamber 6 in such a manner as to allow flow of fluid (indicated by arrows 29) through perforated walls into the chamber 6 and through the collected mixture 16 therein. The mixture 16 flows between elements of the manifolds 21 and 25 which includes perforations for receiving and discharging fluid 29 (here air).

The regenerator system 8 includes a conveyor 32 that operably joins with the separator 7 so as to receive media 14 therefrom and transport the relatively cool dry media to a regenerator 34. The conveyer 32 is rotated by a motor not shown. While the conveyor of the present embodiment is located between the regenerator and the separator, it is foreseen that the conveyor could be located between the regenerator and mixer, that it could be centrally located or that it could be divided into sections on either side of the regenerator. The regenerator could also perform the function of the conveyor in some embodiments.

The regenerator 34 has a tube 35 aligned at an angle with the horizontal and an interior conveyor 37, driven by a motor not shown, that has a series of media receiving pans or buckets 38 that receive the media 14 from the conveyor 32 and that are mounted on a continuously rotating belt 40. It is foreseen that a cable or the like could also be used to move the buckets. It is also foreseen that the regenerator could have a wide range of inclination or none relative to the horizontal in some embodiments, provided that condensate can be collected and drained therefrom. The buckets 38 are constructed of a screen mesh that is sized to hold the media 14, but allows passage of fluid 29 therethrough. Most of the buckets 38 that are shown raising in the regenerator 34 are full of media 14 and the ones going down on the opposite side are empty.

The manifold 21 is flow connected by a conduit 44, having a driving fan 45 therein, with an intermediate location along the regenerator 34. It is foreseen that fan can be also located at the entry to the chamber so as to act as a pusher. The conduit 44 opens at outlet 46 into the tube 35 so that fluid (here indicated by arrow 47) flows into the tube 35 counter flow to the movement of the pans 38 and eventually out a fluid discharge 48. Suitable airlocks, such as airlocks at locations 49 and 52 are provided in the regenerator 34 to direct flow of fluid therethrough.

In a final drying and heating region 51, a small side arm 50 of the conduit 44 directs a small slip stream of the fluid indicated by the arrow 54 out a secondary fluid discharge 55 into the atmosphere. The slip stream 54 is used for the drying or blow away removal of surface moisture and heating of the media 14 and is a small percentage of the overall fluid flow, preferably less than 5% by volume. Such a slip stream 54 works best when the fluid is not fully saturated.

Located between the conduit outlet 46 and the slip stream 54 is a water blow off system 56 that includes a fan 58 to recycle gaseous fluid at a higher velocity past the media 14 to blow beaded moisture or other liquid from the media 14.

Subsequent to the drying and heating region 51, the media 14 enters a supplemental heating region 63. A sensor 64 measures the temperature of the media at the exit thereof and compares the exit temperature to a preselected desirable temperature. A heater 65 is located in the heating region 63 along with a fan 66 that blows fluid past the heater 65 and through the media 14 in the region 63 in response to the actual temperature at the sensor 64 being below the preselected temperature. The preselected temperature is selected for the particular material being dried. For example, the preselected temperature is preferably in a range from 180° to 240° F. for many materials to be dried. For some, the preferred temperature may be higher or lower. For corn, it is preferred that the temperature of the mixture exiting the mixer 5 be in the range from 160° F. to 190° F. Upon startup additional heating by the heater 65 is normally required to bring the media 14 up to temperature, since the media 14 on a cold startup will not be preheated by the fluid exiting the chamber 6. It is foreseen that the heater 65 may utilize many different types of energy, including natural gas, propane, electrical resistance, microwave, oil, biofuel and the like.

The media 14 is dumped from the buckets 38 as such leave the heating region 63 into a chute 69 that collects heated media (indicated by the arrow 70) at the bottom thereof and delivers the heated media 70 to the mixer 5. The regenerator 8 is provided with suitable access locations, not shown, to allow the initial supply of media 14 or makeup media 14 thereto and for maintenance.

In use, the wet material 12 enters the mixer 5 through an airlock 19 and is mixed with comparatively hot media 14 to form mixture 16. The mixture 16 flows into and downwardly through the chamber 6 while the initially cool fluid 29, preferably air at ambient air temperature or about 70° F., flows upwardly in counter flow through the mixture 16. The mixture 16 becomes cooler and drier as it drops lower in the chamber 6 and the fluid 29 becomes hotter and more saturated with moisture as it raises in the chamber 6. The media 14 is separated from the material 12 in the separator 7 and transported to the bottom of the regenerator 34. The material 12, preferably now about the same temperature as prior to entering the drier 1, but comparatively drier, is delivered to storage or transferred to a different location or in some embodiments directed to another pass through the drier 1, if necessary.

The comparatively cool dry media 14 is loaded onto the buckets 38 of the conveyor 37 and passes in counter flow to the comparatively hot and at least partially saturated main stream of fluid that has exited the chamber 6. The media 14 thereby becomes hotter and moisture or other liquid condenses on the media 14 and migrates to the bottom surface of the tube 35. The moisture flows down the bottom surface of the tube 35, here due to the inclination of the tube 35, and exits the drain 60. After the media 14 passes the fluid conduit outlet 46, it is blown dry by the blow dry region 56, thereafter enters the drying and heating region 51 with a concurrent flow of a small slip stream of fluid and thereafter is supplementally heated in the heating region 63 to the preselected temperature, here 210° F.

Thereafter, the heated and relatively dry media 14 is mixed with the incoming material 12 in the mixer 5 and the cycle continues until all material 12 is dried to a selected moisture content that is chosen for the particular material 12 to be dried.

Shown in FIG. 1A is drier 80 that in many ways is quite similar to drier 1. Consequently, only major elements and the elements that are different are discussed in detail. Reference is made to the description of drier 1 for the remainder of the description of drier 80.

Drier 80 includes a mixer 81, a drying chamber 82, a separator 83 and a regenerator 84.

The principal difference in the drier 80 as compared to the drier 1 is that conduits 87 and 90 are provided to collect fluid exiting the regenerator 84 at outlets 91 and 92 respectfully. The conduits 87 and 90 join in a common manifold 95 that recycles the fluid indicated by flow arrows 97 back to a lower chamber manifold 99 for distribution through a perforated fluid dispenser 100 into a mixture 101 in the chamber 82. Located along the manifold 95 is a chiller 105 of conventional refrigeration unit construction, including commercial air condition units, refrigeration units, heat exchanger with ambient air, heat pumps and similar devices, having a condensate drain 106 utilizing a heat exchanger and air cooling unit (not shown) to cool the fluid in the manifold 95 to a preselected temperature, for example 70° F., and dew point temperature. The purpose of the chiller 105 is to return the fluid 97 to essentially the same starting temperature and to adjust the dew point temperature of the fluid 97 at the bottom of the chamber 82 for each cycle thereof, so that the fluid 97 does not increase somewhat in temperature or decrease in moisture holding capacity with each cycle. It is foreseen that the chiller could be located other places in the system and perform an equivalent function, such as along a conveyor 104 that conveys media 115 between the separator 83 and regenerator 84, so as to remove a small amount of heat by condensing liquid at such location. It is foreseen that the heat from the chiller 105 could be conserved and used to help preheat the media 115. It is also foreseen that the chiller could be a heat pump or other suitable device for removing heat and that such heat could be returned to the drier 80 for use in heating the media 115 or the mixture 101 or the like.

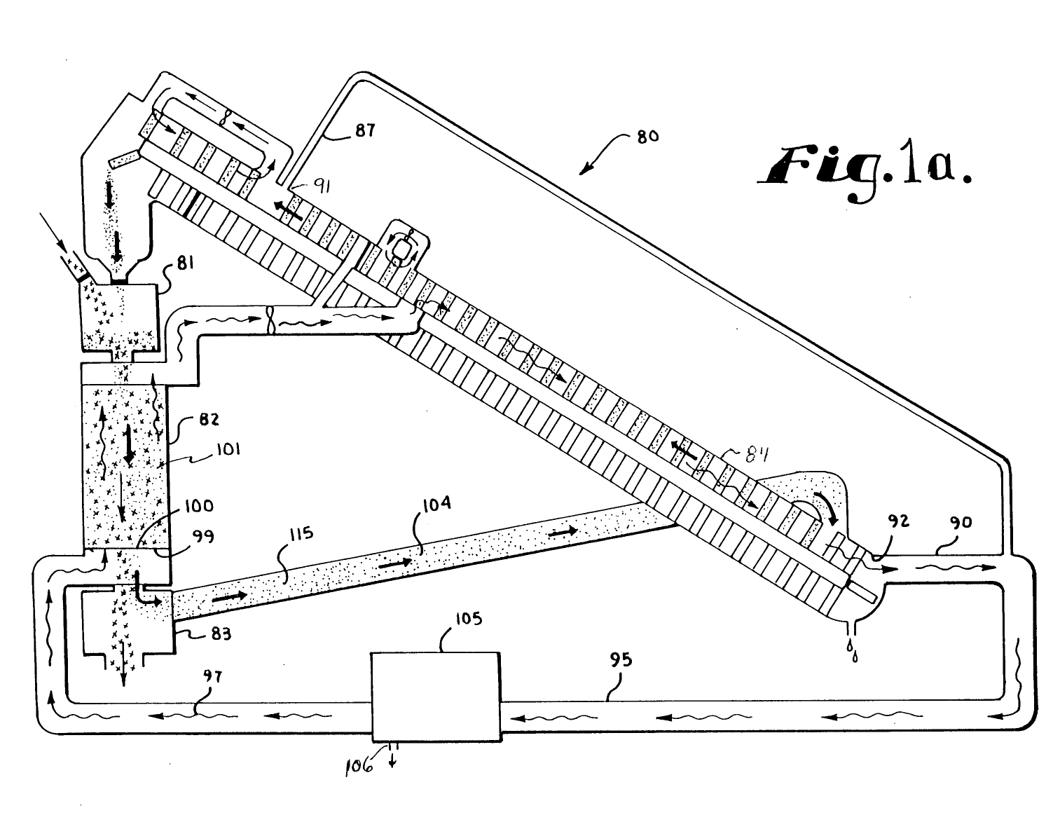

Shown in FIG. 2 is a drier 120. The drier 120 is similar to the previous described drier 1 and portions that are the same are not described again in detail, but rather reference is made to the description of drier 1.

Drier 120 has a mixer 123, a drying chamber 124, a separator 125 and a regenerator 126. The principal difference here as compared to drier 1 is that the vertical column drying chamber of drier 1 has been replaced with a horizontal fluidized bed chamber 130. The chamber 130 has a perforated floor 132 suspended therein which receives a mixture 133 of material 134 to be dried and heated media 135 from the mixer 123. The chamber 130 has an enclosed outer wall 137 from which suspend a series of spaced upper and lower fluid flow directing baffles 139a and 139b. A series of upper ports 140 is connected to a series of lower ports 141 by conduits 142 having a driving fan 143 therein that circulates fluid in the portion of chamber 124 that is located between each associated or adjacent pair of baffles 139a and 139b, such as represented by the arrows 145 from ports 140 to ports 141 and then through the floor 132 to fluidize a mixture bed 144 thereon and returning, in a large part, to ports 40. In this manner, fluid represented by arrow 147 passes through the fluidized bed 144 and is moving counter flow to the mixture 133, while at the same time a significant flow of fluid 145 is being flowed upwardly through the bed 144. The mixture bed 144 is fluidized and flows generally to the right as seen in FIG. 2. Where needed, the floor 132 may be slanted toward the outlet, an open grid chain can be drawn through the bed 144 toward the outlet or other structure can be used to facilitate movement of the bed 144 over the floor 132.

Shown in FIG. 2A is a drier 160 similar to drier 120 except as described below. The drier 160 has a mixer 161, a fluidized bed drying chamber 162, a separator 163 and a regenerator 164. In drier 160, collection conduits 165 and 166 collect fluid exiting the regenerator 164 at discharge locations 167 and 168 respectively. The conduits 165 and 166 join in a common manifold 170 that is in flow communication with the location 171 whereat the fluid enters the chamber 162 to operably recycle fluid as represented by arrow 172 within a substantially closed system. Located along the manifold 170 is a chiller 174 with a liquid drain 175 for chilling the fluid to a preselected temperature and dew point temperature.

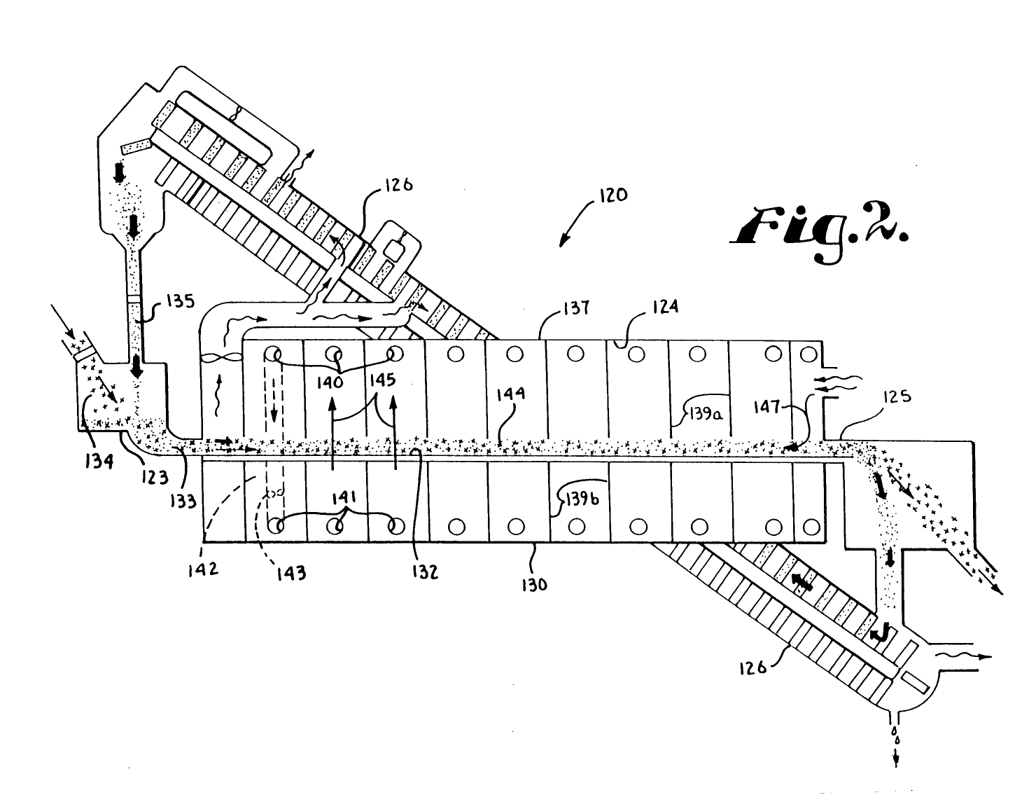

FIG. 3 shows a drier 180 which is similar to drier 1 and includes a mixer 181, a drying chamber 182, a separator 183 and a regenerator 184. The drying chamber 182 differs from that of drier 1 in that it has a rotary drum 185. The drum 185 includes a cylindrical shell 186 that operably rotates and that has a series of spaced suspended stationary baffles 187 that urge the fluid represented by arrows 188 to pass through a rotating mixture 189. The baffles 187 are supported by a shaft 190 that extends through the shell 186. The shaft 190 and baffles 187 do not rotate with the shell 186, so that the flow of fluid 188 is always beneath a bottom 191 of the baffles 187. In the view of FIG. 3, the mixture 189 moves from left to right as the fluid 188 moves from right to left through the drum 185.

FIG. 3A shows a drier 200 that is similar to drier 180 and has a mixer 201, drying chamber 202, a separator 203 and a regenerator 204. The drier 200 differs from drier 180 in that it includes a fluid collection and return manifold system 206 with collection conduits 207 and 208 that collects fluid exiting the regenerator 204 and returns the fluid represented by the arrow 205 to the drying chamber 202. The return manifold system 206 also includes a fluid chiller 210 for chilling the fluid to a state having a preselected temperature and dew point temperature with a liquid drain 211.

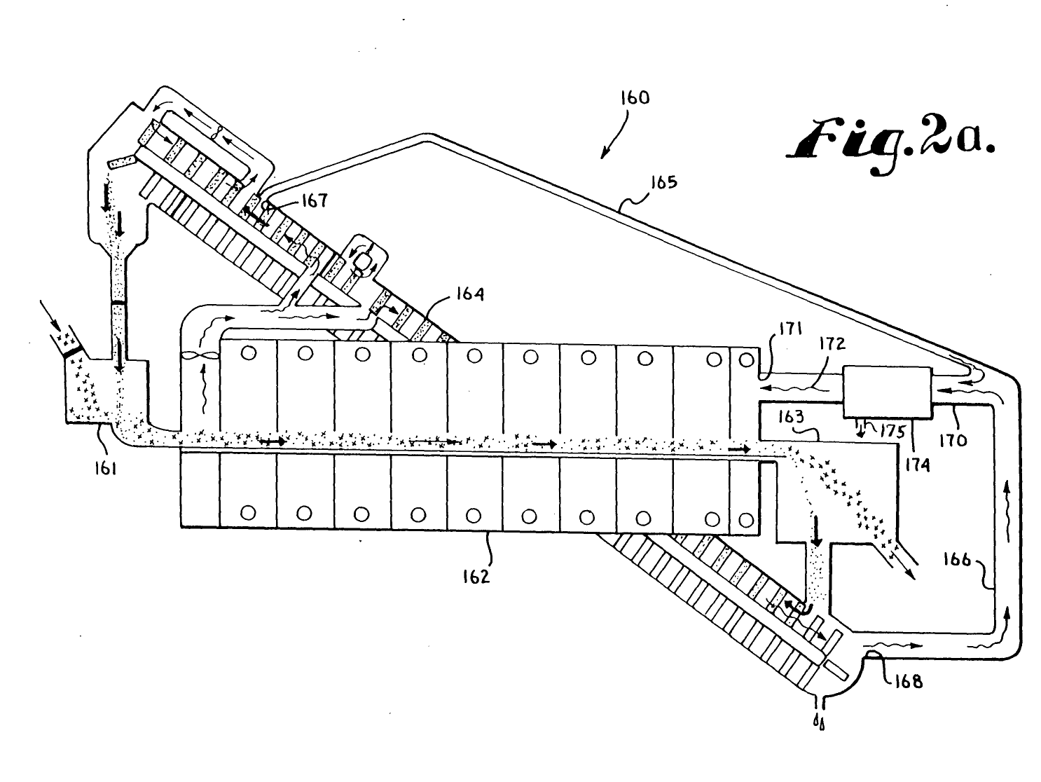

Shown in FIG. 4 is a drier 240 that is further similar to drier 1 in that it has a mixer 241, a drying chamber 242, a separator 243 and a regenerator 244. The regenerator 244 differs from that of drier 1 in that there is a vertical tower 250 having an internal bucket conveyor 251 that conveys media 252 from a lower end 253 to an upper end 254 thereof and discharges the media 252 into a hopper and heating chamber 256 that is part of the regenerator 244. The media 252 in the heating chamber 256 is located above a series of rotating gates 257 that feed the media 252 therethrough by gravity. Fluid indicated by arrows 260 and driven by fan 261 upon exiting the chamber 242 is conveyed by a manifold 262 to beneath the gates 257 so that the fluid which is hot passes through the gates 257 and lower structure of the heating chamber 256, so as to heat the media 252. Subsequently, the media 252 collects at the chute 265 and passes through a pair of rotating foam rollers 267 at nip 268 which function to substantially remove the moisture condensed on the media 252. Squeegees 270 operably squeeze water from the rollers 267. Collected moisture indicated by the arrow 269 exits at drain 271.

A secondary or supplemental cross flow heater 272 provides additional heating to the partially heated media 252 to bring it to a desired or preselected temperature. It is foreseen that the fan 261 could be stopped during startup.

Drier 280 is shown in FIG. 4A and includes a mixer 281, drying chamber 282, separator 283 and regenerator 285. The drier 280 is like drier 240 except the fluid exiting the regenerator 285 and indicated by arrows 287 is collected in a manifold 288 and returned to the bottom of the drying chamber 282 in a generally closed loop through a chiller 290 having a drain 291. The chiller 290 being for chilling the fluid to a preselected temperature and dew point temperature.

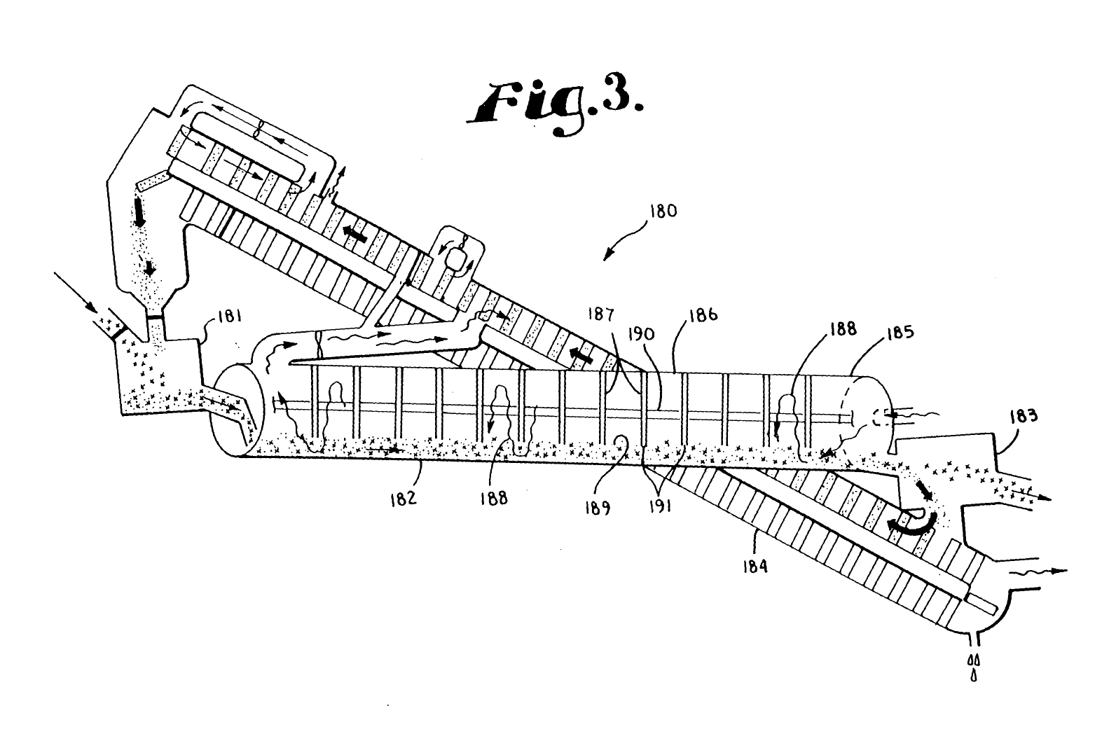

FIG. 5 shows a drier 300 that is similar to previous fluidized bed drier 120 in part and prior drier 240 in part. In particular, drier 300 includes a mixer 301, drying chamber 302 that provides a fluidized bed 303 of the mixture 304 to be dried, a separator 305 and a regenerator 306 which is similar to regenerator 244 except that media 308 is returned by conveyor 309 for reheating.

Drier 320 of FIG. 5A is similar to drier 300 and includes mixer 321, drying chamber 322, separator 323 and regenerator 324. Drier 320 also includes a manifold 325 collecting fluid exiting the regenerator 324 and returning the fluid to the drying chamber 322 through a chiller 326 for chilling the fluid to a preselected temperature and dew point temperature and having a drain 327.

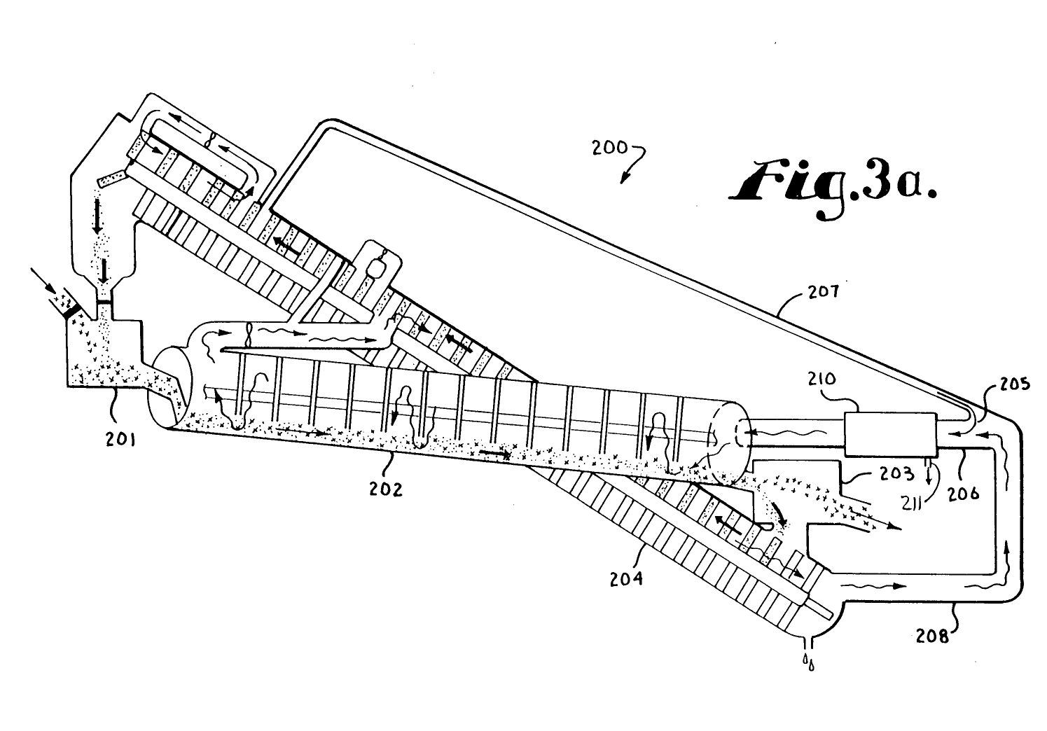

Shown in FIG. 6 is a drier 350 having a mixer 351, drying chamber 352, separator 353 and regenerator 354. The drying chamber 352 is similar to previously described chamber 182 and the regenerator 353 is similar to that of the previous regenerator 306. A conveyor 355 carries media 356 from the separator 353 to the top of the regenerator 354 for reheating.

Shown in FIG. 6A is a drier 380 that is similar to drier 350 and includes a mixer 381, drying chamber 382, a separator 383 and a regenerator 384. The drier 380 includes a fluid collection manifold 385 with a chiller 386 having a drain 387 to operably return fluid from the regenerator 384 to the chamber 382 at a preselected temperature and dew point temperature.

It is foreseen that the fluid driving mechanism, such as fan 45 of dryer 1 of the first embodiment could be located downstream of the drying chamber (that is, in the fluid path after the fluid exits the chamber) and pull the fluid through the chamber, such as chamber 6 in drier 1 or could be upstream of the chamber (that is, prior to the fluid entering the chamber) and push the fluid through.

It is foreseen that supplemental heat could be added to the drier to make up for losses in the method at many locations. In the embodiments shown, the heat is added subsequent to the heat exchange between the fluid and the media in the regenerator. However, the supplemental heat could be added to the material to be dried, to the media while in the regenerator or to the fluid prior to entering the regenerator and in other ways.

While a continuous counter flow process is described for the chamber and most of the regenerator in the embodiments described, it is foreseen that batch processes could be utilized using one or a series of sequential batch operations. Further, it is foreseen that the flow of fluid into the mixture in the chamber and into the media in the regenerator could be step wise cross flow, step non counter current flow and other flow configurations including mixed configurations wherein each segment or section may encounter one or more different types of flow, but the overall general path of flow of the fluid is counter current to the material to be dried in the chamber.

It is foreseen that the mixture may be conveyed through the chamber and/or the regenerator by other types of systems including, but not limited to, round plate systems, tunnel driers, column driers with flow directing auger especially upward flow column driers, driers using belts to convey mixture therethrough, vibratory inclined plane elevator driers, vibratory spiral elevator driers, modified conventional round bin grain driers, disc driers, screw driers and plough driers, as well as driers of other types especially suitable to the material to be dried and various mixtures of drier type.

It is further foreseen that in the rotary drum embodiments of the drier, that the baffles could be eliminated by making the drum of a relatively narrow cross section so that the fluid flows generally countercurrent through a cascading mixture in the chamber.

It is also foreseen that although the embodiments shown are principally directed to removing moisture from a material to be dried, that the process can be used to remove other evaporatable liquids such as solvents or the total vaporization of an incoming fluid as an evaporator. The process of the invention is highly adaptable to any situation where there is a vaporizable and condensible component that can be carried by a carrier or drying (here cooling) fluid so as to be removed from another component or fully evaporated and that thermodynamically saves energy over conventional processes. It is noted that in some chemical processes the component to be removed may not be wasted, but rather recovered for reuse. The latter is especially true in solvent recovery.

It is foreseen that in certain embodiments that the drying chambers of the process may be operated under a partial or full vacuum in order to enhance evaporation of a fluid to be dried from the material to be dried, especially to reduce energy consumption or to increase capacity.

It is foreseen that multiple drying chambers may be utilized with a single regenerator so that fluid from separate chambers all enters the common regenerator and all media also enters the regenerator for reheating. For example, separate compartments or chambers could be spaced and the cooling fluid could pass between the different chambers, or may return to the regenerator after exiting each chamber such as is shown in FIG. 1. With separated chambers, different materials to be dried by use of different feed paths or materials at different moisture content could be dried in separate chambers.

While the illustrated embodiments physically mix the material to be dried with the media, it is foreseen that in some instances the hot media could flow along side the material to be dried, but be separated by perforated walls in which case cooling fluid in a mixture of cross and counter current flow could pass through both whereby the fluid would be heated as well as the material by the media and the fluid would withdraw moisture or other liquids from the material. It is also foreseen that a heated liquid may be flowed in closed tubes passing through the material to be dried and wherein the liquid flows generally concurrent with the material to be dried and a cross flow and counter current flow fluid flows through the material to be dried such that the fluid and the material are heated by the liquid in the tubes which may include heat transfer fins and the like, so that the fluid removes moisture or other liquids from the material to be dried.

While air and nitrogen are the most likely fluids to be used in a process of this type, it is foreseen that other fluids such as argon or the like may be used. Furthermore, while particular materials to be dried have been mentioned herein, it is foreseen that a wide variety of materials may be dried, including particulates and other granular materials, powders, flakes, pastes, slurries, and solids in general. Such materials are not restricted to but may be represented by foodstuffs, such as grains, beans, dog food, mixes, meals and flours; chemicals such as clays, coals, sand; and processed materials, such as paper and the like. Still furthermore, it is foreseen that the media may be chosen from a wide range of materials including, but not limited to, crystals, minerals, salts, sands, metal pellets and balls, pea gravel, ceramic pellets or balls, composite materials such as ceramic or concrete pellets with imbedded iron filings and the like.

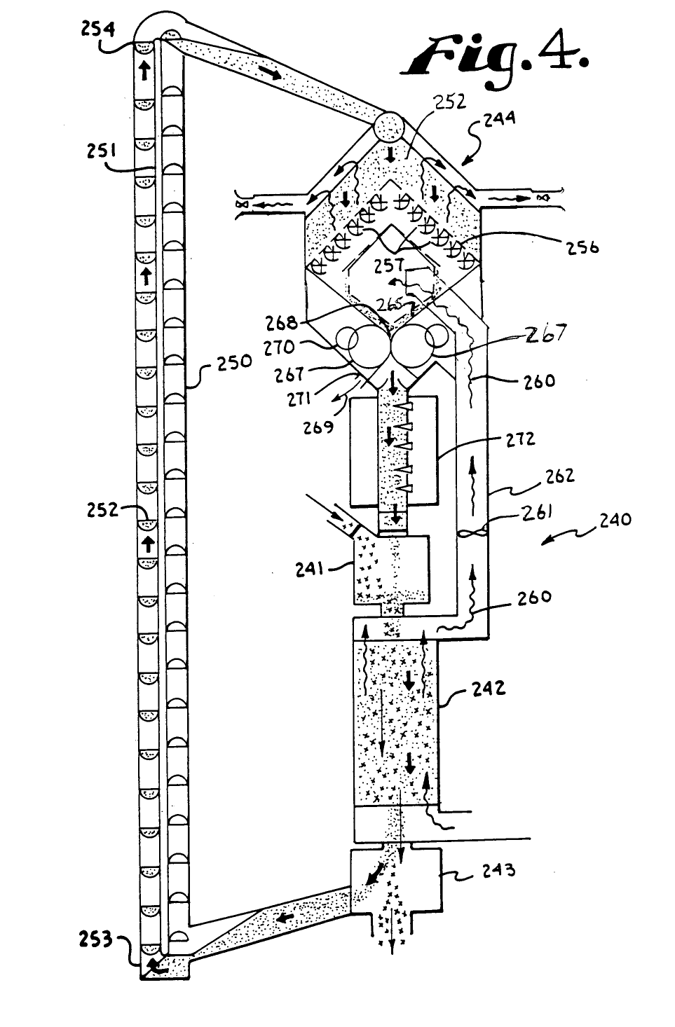

Shown in FIG. 7 is an alternative regenerator generally identified by the reference numeral 400 for use in conjunction with a drier, such as drier 1 as an alternative to regenerator 34.

The regenerator 400 includes an enclosure or housing 405 forming an enclosed interior region or chamber 406. Positioned across the chamber 406 and in the shape of an inverted V is an upper guide structure 408 having a plurality of spaced gaps 409 therein sufficient to allow passage of media 410 therethrough. The general flow of media 410 is indicated by the cross hatched arrows. Flow of media 410 through the guide structure 408 is controlled by metering rollers 411 and a diverter 412. A lower V-shaped and perforated wall 413 is located beneath the guide structure 408. The wall 413 has perforations sufficiently large to allow flow of fluid, as represented by the arrows 420, but sufficiently small to prevent passage of media 410 therethrough. The wall 413 acts as a directing funnel and has a slot or gap 421 at the bottom thereof. Located above the guide structure 408 is a second perforated wall 422 to allow passage of the fluid 420 from the chamber 406 and into collecting conduits 425 for discharge through outlets 426. Media 410 enters the chamber 406 through a hopper 429 under the control of an auger 430. Fluid 420 is conveyed to the chamber 406 by conduit 432 and is circulated therein by a fan 433.

The media 410 feeds through gap 421 into a pair of sponge rollers 440 that are sufficiently soft to not damage the media 410 but act as an airlock to resist flow of fluid 420 therethrough and absorb moisture from condensate collected on the media 410. Squeegee rollers 442 abut against rollers 440 and squeeze moisture due to condensate on the media 410 from the rollers 440. The condensate so collected and otherwise formed in the chamber 406 and indicated by drops 443 collects in traps 444 and is discharged through airlock drains 445. An auger 447 dischargers the media 410 from the chamber 406.

The media 410 thus enters the regenerator 400 in a cool state and passes in heat transfer contact through the fluid in a heated state so that the media exits the regenerator 400 as indicated at the arrow 449 in a heated state for return for mixing with incoming material to be dried. The media 410 in a heated state, after leaving the regenerator, will normally thereafter pass through a makeup or supplemental heater to bring the media 410 to a preselected temperature prior to being mixed with incoming material to be dried.

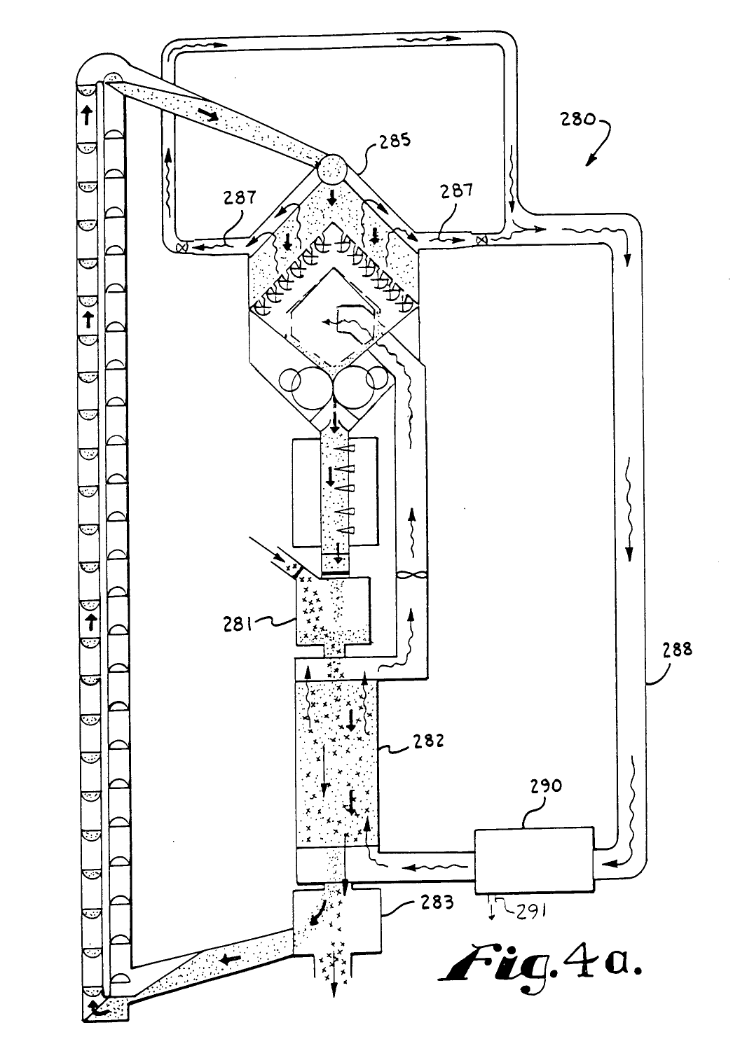

FIG. 8 shows another alternative regenerator for the drier 1 generally identified by the reference numeral 450. The regenerator 450 has a housing 451 forming a generally enclosed chamber 452. Mounted in the chamber 452 are a series of perforated divider walls 455 that extend horizontally in side by side fashion and have a sloped portion 456. Between each adjacent pair of walls 455 is a slot 457 with a metering roller 458 at the bottom thereof. It is foreseen that instead of the metering rollers that other devices such as timed flaps could be used to control flow of media 459 through the slots 457.

Media in a cool state and identified throughout the process by the reference numeral 459 and the cross hatched arrows, enters the chamber 452 through a hopper 460 under the control of an auger 461. The material 459 flows into and collects in a region 463 above the divider walls 455.

Fluid, as generally indicated by the directional arrow with the reference numeral 466 enters the chamber 452 from a conduit 469 operably joined to a drying chamber such as in drier 1 and exits through outlet 470 while being driven by a fan 471. The fluid 466 flows upwardly through the perforated walls 455 and subsequently through the media 459 located above the walls 455 thereby transferring heat from the fluid 466 to the media 459.

The media 459 is discharged by the metering rollers 457 onto a belt or drag conveyor 475 which in turn conveys the media 459 to a collection chute 476. The media 459 passes through the chute 476 under control of a pair of sponge rollers 479 that absorb moisture from the media 459 and operably function as an airlock to resist passage of fluid 466 therethrough. Squeegee rollers 480 engage the sponge rollers 479 and squeeze water therefrom.

Moisture, as indicated by the reference numeral 481 and drops within the chamber 452, is collected in traps 482 and discharged through air flow resistant drains 483. The material 459 in a warm or heated state exits the regenerator 450 under the control of an auger 485 at outlet 486 and is returned to mix with material to be dried. After being partially heated in the regenerator 550, the media 459 is directed from the regenerator 550 to a supplemental or makeup heater (not shown) and heated to a preselected temperature and thereafter mixed with incoming material to be dried.

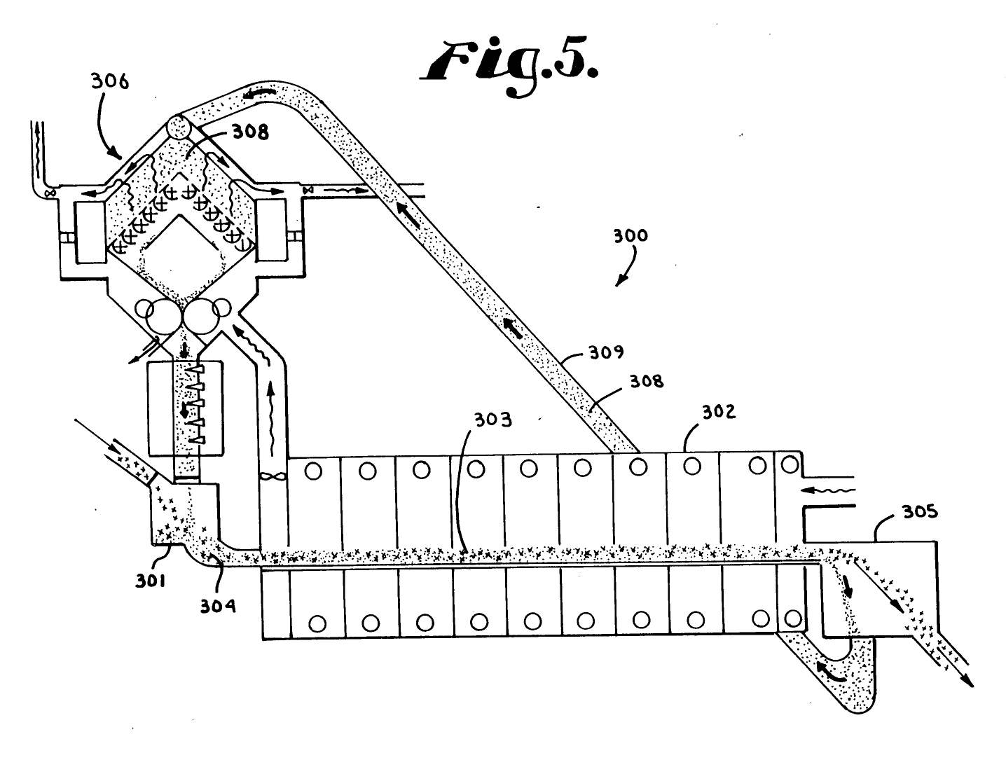

Shown in FIG. 9 is another regenerator generally identified by the reference numeral 500. The regenerator 500 is utilized in conjunction with heated media driers of the type such as drier 1.

The regenerator 500 includes a bin 502 of the type used for grain storage and the like. Media, as indicated by cross hatched arrows with the reference numeral 504 throughout, enters the bin 502 through an upper chute 505 in a cool state and is discharged into an internal chamber 508. Fluid, as represented by directional arrows 509 and in a heated state from a drying process is conveyed to the chamber 508 by inlet conduits 512 and discharged through outlets 513. Located in the bottom of the chamber 508 is a perforated floor 520 beneath which the fluid 509 enters the chamber 508 so as to pass upward through the floor 520, through the media 504 and then out the outlets 513.

Media 504 is continuously raked by a sweep auger 522 along the top of the floor 520 toward a central collector 525. The media 504 is conveyed from the central collector 525 by an auger 526, or the like and discharged in a warm or hot state at discharge 529 for return for mixing with material to be dried. The media 504 after being warmed in the regenerator 500 is directed to a supplemental or makeup heater (not shown) and heated to a preselected temperature after which the media 504 is mixed with incoming material to be dried. Moisture produced by condensate formed on the media 504 drops through the perforated floor 520 and is collected and discharged from drains 540 separate from the media 504.

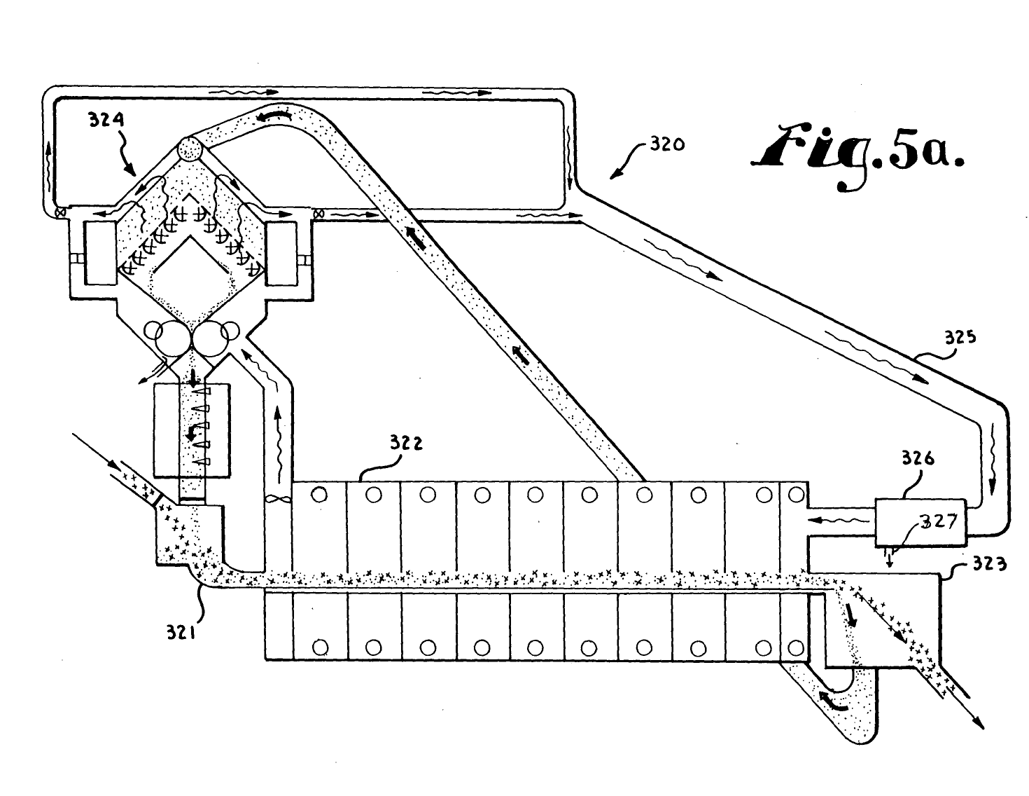

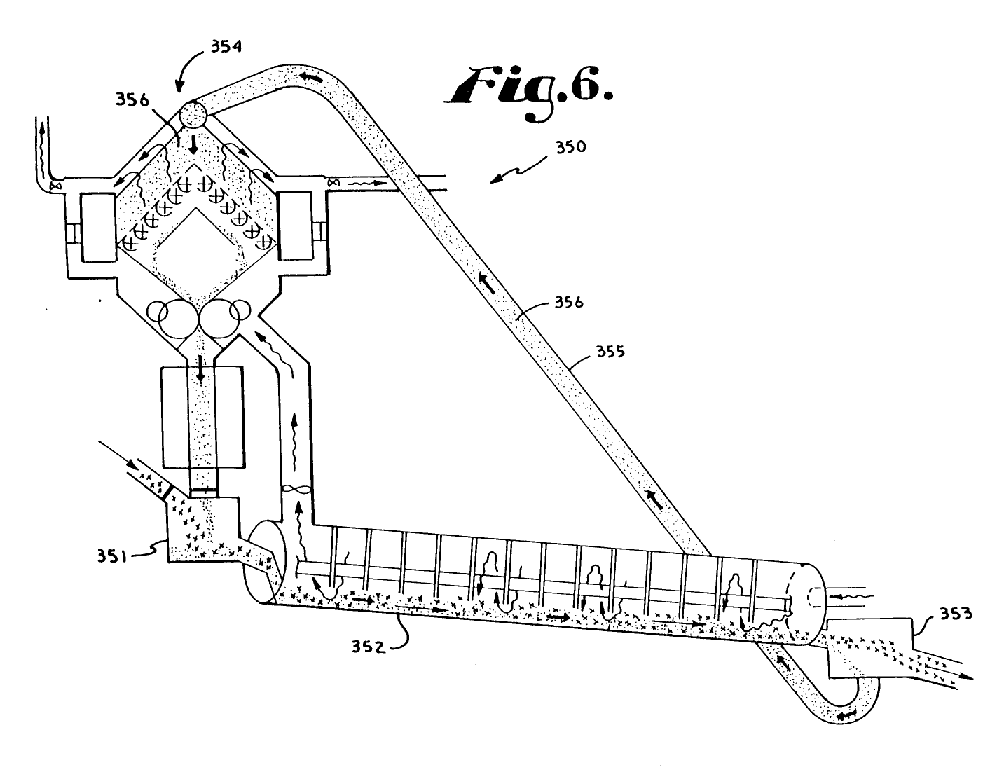

Shown in FIGS. 10 and 11 is a regenerator generally identified by the reference numeral 550. The regenerator 550 can be used to reheat media, generally identified by the reference numeral 552 and the cross hatched arrows that is thereafter used to heat material to be dried such as in the drier 1 described before.

The regenerator 550 includes a cylindrical and generally enclosed shell 551 forming an interior chamber 553. The regenerator 550 is of a vibratory spiral elevator type. The media 552 enters the regenerator 550 through inlet 560 and flows onto a spirally wound and continuous perforated plate 562 situated about a central core 563. The plate 562 is continuously vibrated and the media 552 travels around the plate 562 and upward to exit the regenerator 550 at an outlet 565.

Fluid, as represented by the arrow 570 enters the regenerator 550 through inlet 572 and is driven by a fan 573. The fluid exits the regenerator 550 through lower outlets 575. The plate 562 is perforated to allow passage of the fluid 570, but not of the media 552, therethough. In this manner the fluid 570 flows through the media 552 as the media 552 travels along the plate 562, such that the media 552 exits the regenerator 550 in a heated state for return to be mixed with material to be dried. The media 552 in the heated state after leaving the regenerator 550 normally passes through a supplemental or makeup heater (not shown) where the media 552 is heated to a preselected temperature prior to mixing with material to be dried. Condensate indicated by drips and the reference numeral 580 is collected and discharged at drains 581.

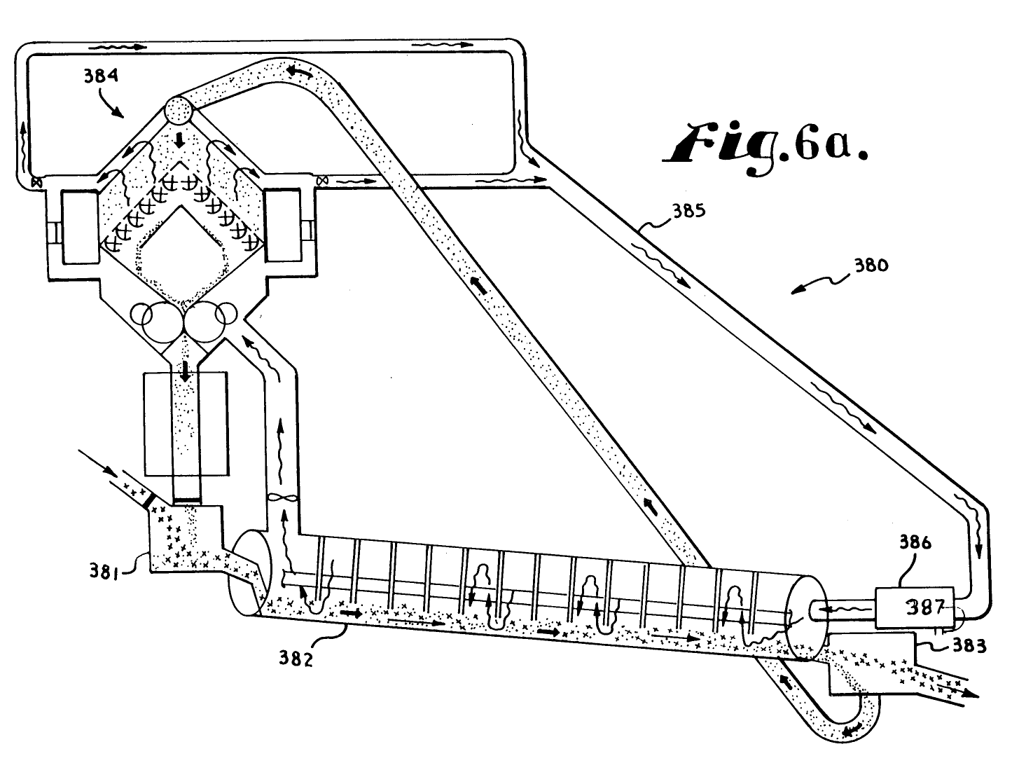

Illustrated in FIG. 12 is a regenerator generally identified by the reference numeral 600. The regenerator 600 is for use in reheating media used in turn to heat material to be dried in devices such as drier 1 described above.

The regenerator 600 includes an enclosed elongate and inclined column 602 having an interior chamber 604. Media, as indicated by solid arrows and the reference numeral 605, is loaded into the chamber 604 through an inlet 607 under control of an auger 608. The media 605 flows downwardly through the chamber 604 due to gravity and exits through an outlet 610 under control of a metering roll 611 and is returned in a heated state to mix with material to be dried by an auger 614. Media 605 that has been warmed or preheated to a heated state in the regenerator 600 normally thereafter flows through a supplemental or makeup heater (not shown) to heat the media 605 to a preselected temperature prior to mixing with incoming material to be dried.

Fluid, as generally indicated by the directional arrow 620 enters the chamber 604 through an inlet 622 under control of a fan 623 in a heated state. A series of bypass loops 630 join with alternating sides of the column 602 to provide a flow for the fluid 620 in a cross flow pattern. A perforated screen 631 prevents media 605 from entering the loops 630. In this manner, the chamber 604 is subdivided into a plurality of regions or sectors 633 through which the fluid 620 sequentially passes. The fluid 620 flows through each region 633 generally in cross flow, while on an overall basis the fluid 620 flows countercurrent to the flow of the media 605 throughout the regenerator 600 as a whole. Traps 235 with drains are located on each depending loop 630 and elsewhere through process as needed to collect and discharge condensate.

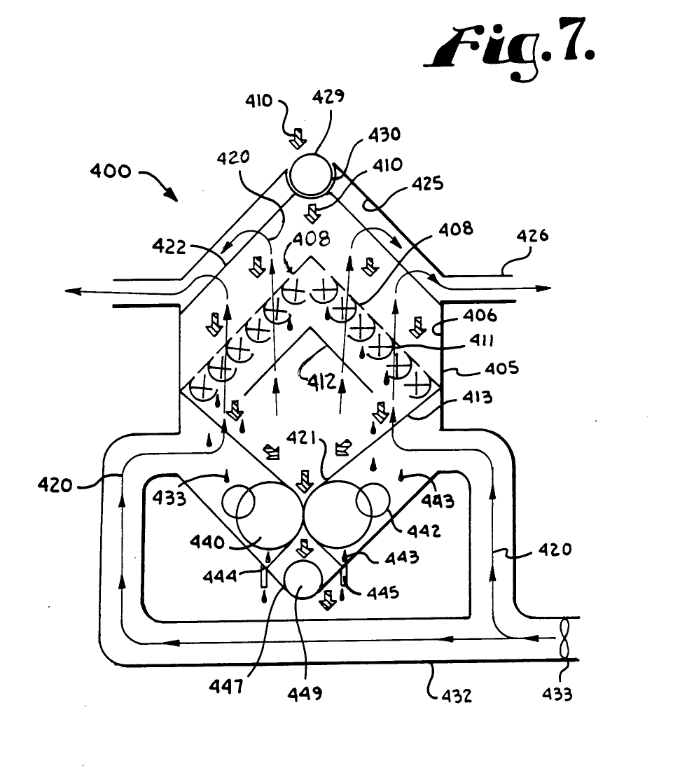

Shown schematically in FIG. 13 is an alternative drying chamber 701 that has a plurality of compartments 702 to 704, although it is foreseen that any number of multiple chambers could be utilized. A mixture 706 to be dried flows generally from left to right through the chamber 701, passing through each compartment 702 to 704 in sequence. A drying and cooling fluid 708 flows overall generally counter flow to the mixture 706, but in each of the compartments 704 to 702 sequentially the fluid 708 flows concurrently with the mixture 706. Suitable baffles and airlocks are provided to allow the flows. It is foreseen that for some configurations, a plurality of individual discrete sided compartments may not be required to properly direct the flows, but rather flow may be controlled in sectors or regions.

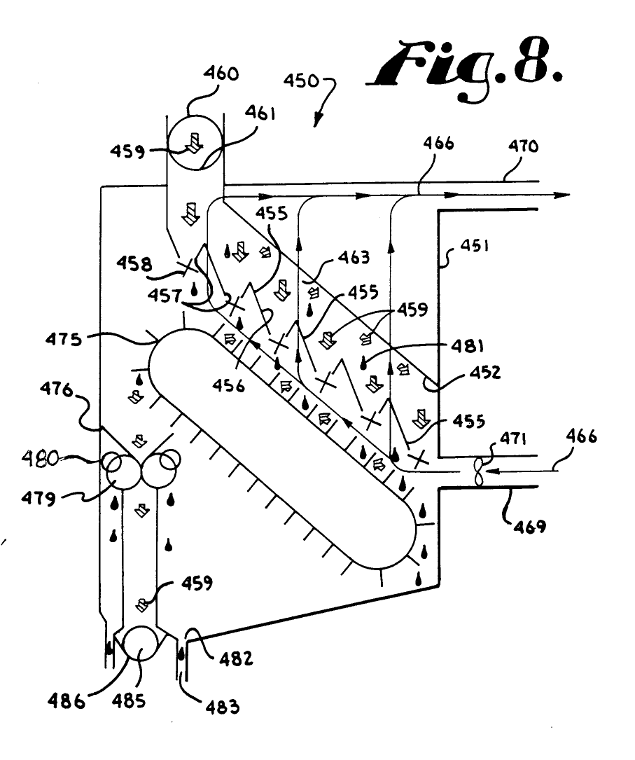

Shown schematically in FIG. 14 is an alternative drying chamber 721 that has a plurality of compartments 722 to 724, although it is foreseen that any number of multiple chambers could be utilized. A mixture 726 to be dried flows generally from left to right through the chamber 721, passing through each compartment 722 to 724 in sequence. A drying and cooling fluid 728 flows overall generally counter flow to the mixture 726, but in each of the compartments 724 to 722 in sequence the fluid 728 flows cross flow relative to the mixture 726. Suitable baffles and airlocks are provided to allow the flows. It is foreseen that for some configurations, a plurality of individual discrete sided compartments may not be required to properly direct the flows, but rather flow may be controlled in sectors or regions.

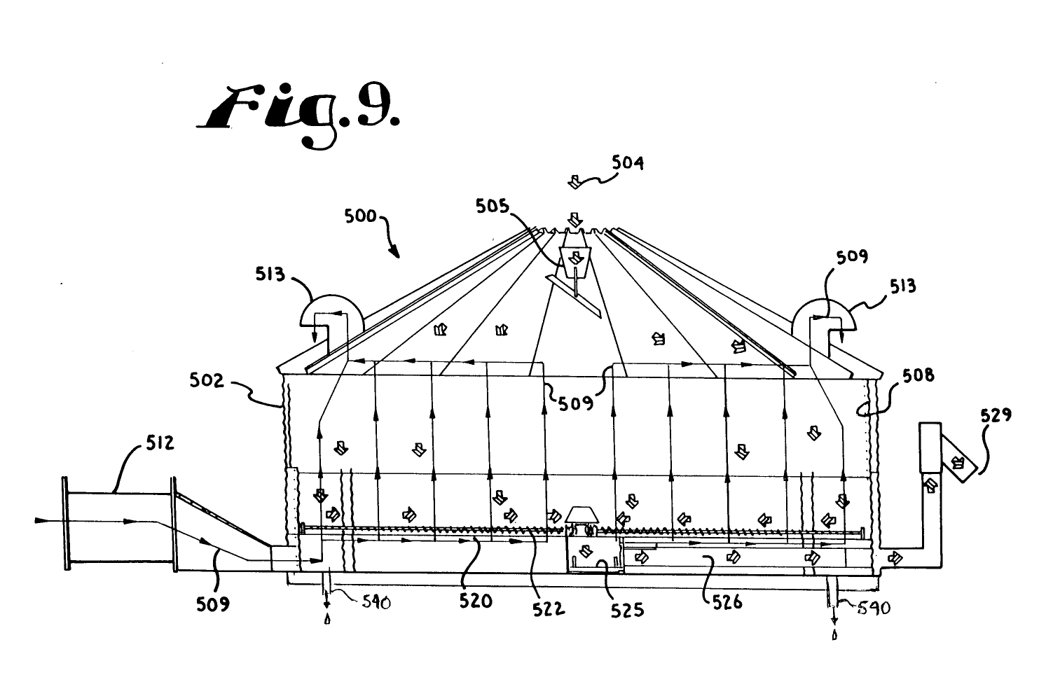

Shown schematically in FIG. 15 is an alternative drying chamber 741 that has a plurality of compartments 742 to 744, although it is foreseen that any number of multiple chambers could be utilized. A mixture 746 to be dried flows generally from left to right through the chamber 741, passing through each compartment 742 to 744 in sequence. A drying and cooling fluid 748 flows overall generally counter flow to the mixture 746, but in each of the compartments 744 to 742 the fluid 748 flows differently with respect to each other. In compartment 744 the fluid 748 flows counter currently with the mixture 746, in compartment 743 the fluid 748 flows cross flow with respect to the mixture 746 and in compartment 742 the fluid 748 flows concurrently with the mixture 746. Such combination of different flow paths is generally referred to herein as mixed flow and it is foreseen that such could be any combination of such flow paths in different compartments. In some instances different or mixed flow paths are combined in the same compartment, such as is shown in FIG. 2 wherein each compartment has both countercurrent flow and cross flow of the fluid passing therethrough. It is foreseen that unitary flow paths within individual chambers or other combinations of combined or sequential mixed flows in various chambers may be desirable for certain applications. Suitable baffles and airlocks are provided to allow the flows. It is foreseen that for some configurations, a plurality of individual discrete sided compartments may not be required to properly direct the flows, but rather flow may be controlled in sectors or regions.

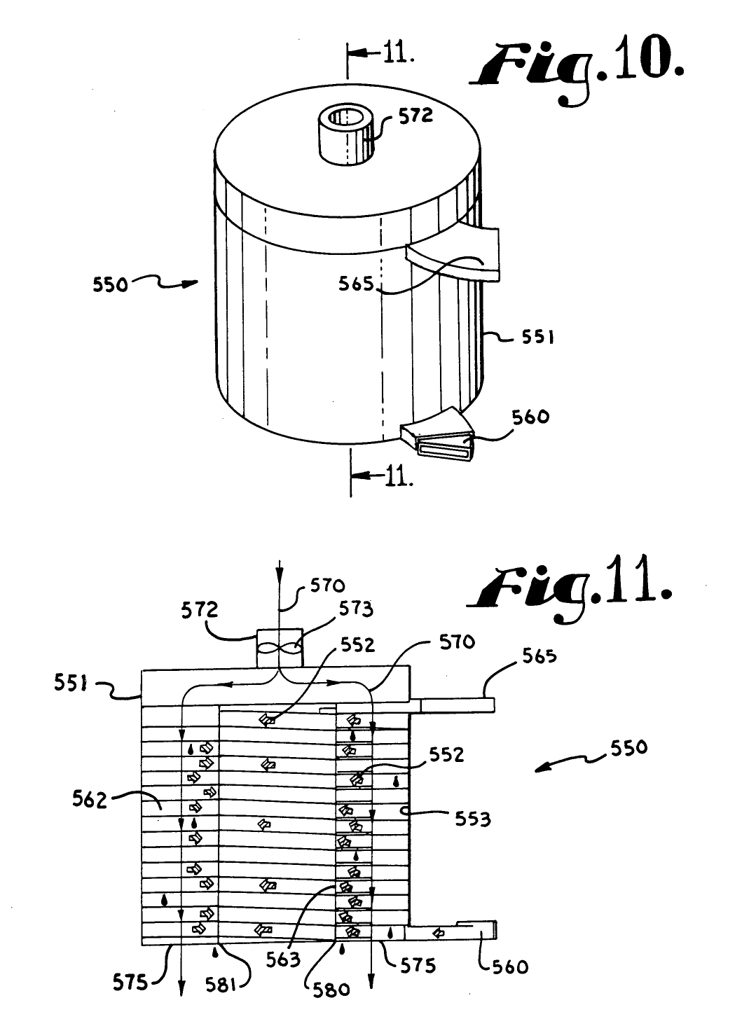

Shown schematically in FIG. 16 is an alternative regenerator 751. The regenerator 751 has a plurality of compartments 752 to 754, although it is foreseen that any plural number of compartments may be utilized. Media 756 in a comparatively cool state enters the regenerator 751 passing from left to right and flows sequentially through each compartment 752 to 754. A hot fluid 758 flows overall generally counter current to the media 756, but within each of the compartments 754 to 752 in sequence the fluid flows concurrently with the media 756. Suitable baffles and airlocks are provided to allow the flow. It is foreseen that for some configurations, a plurality of individual discrete sided compartments may not be required to properly direct the flows, but rather flow may be controlled in sectors or regions.

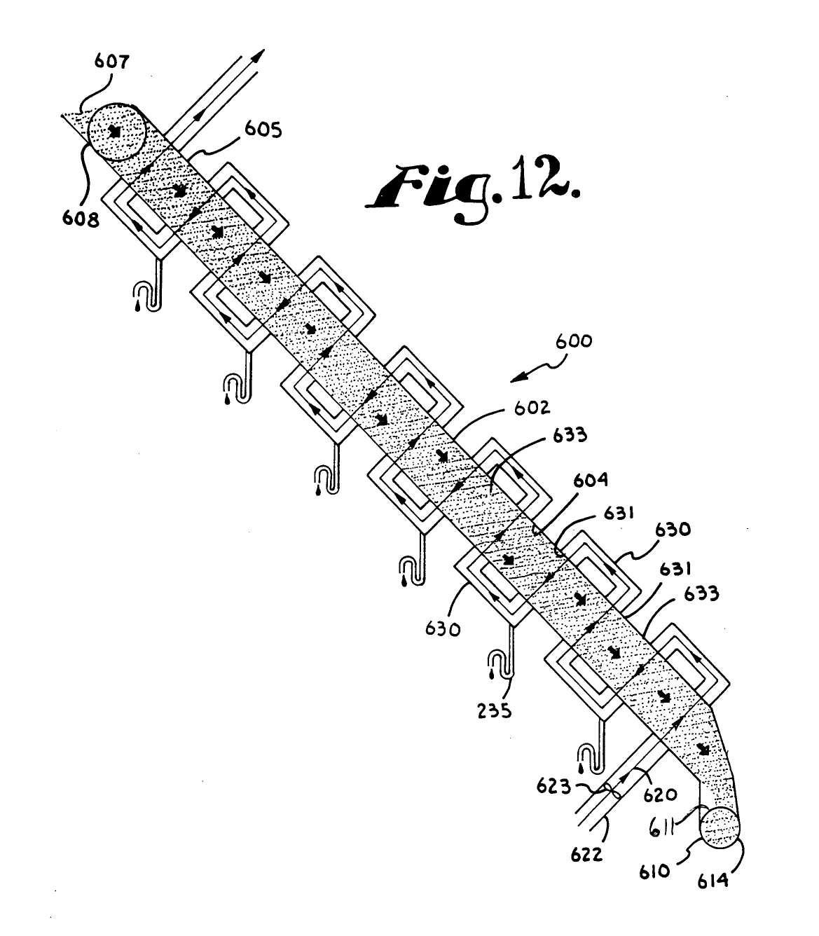

Shown schematically in FIG. 17 is an alternative regenerator 761. The regenerator 761 has a plurality of compartments 762 to 764, although it is foreseen that any plural number of compartments may be utilized. Media 766 in a comparatively cool state enters the regenerator 761 passing from left to right. A hot fluid 768 flows overall generally counter current to the media 766, but within each of the compartments 764 to 762 in sequence the fluid 768 flows cross flow through the media 766. Suitable baffles and airlocks are provided to allow the flow. It is foreseen that for some configurations, a plurality of individual discrete sided compartments may not be required to properly direct the flows, but rather flow may be controlled in sectors or regions.

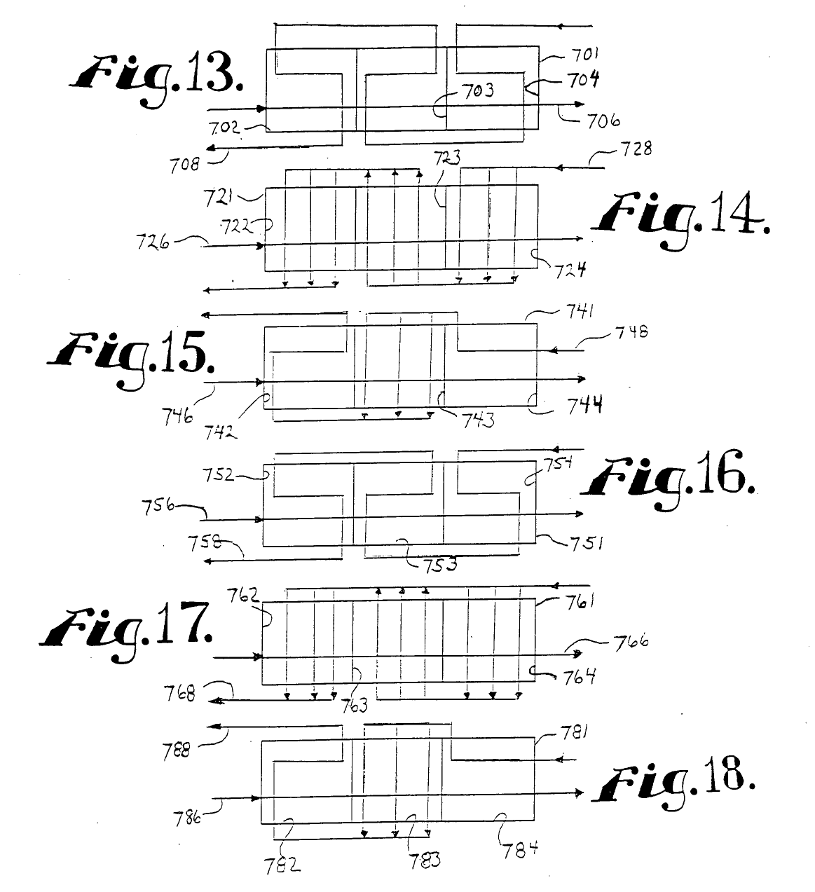

Shown schematically in FIG. 18 is an alternative regenerator 781. The regenerator 781 has a plurality of compartments 782 to 784, although it is foreseen that any plural number of compartments may be utilized. Media 786 in a comparatively cool state enters the regenerator 781 passing from left to right. A hot fluid 788 flows overall generally counter current to the media 786, but within each compartments 784 to 782 in sequence the fluid 788 flows in mixed flow relative to the media 786. In particular in chamber 784 the fluid 788 flows counter current to the media 786, in chamber 783 the fluid 788 flows cross flow through the media 786 and in chamber 782 the fluid 788 flows concurrently with the media 786. It is foreseen that mixed flows of various combinations may be utilized in different compartments wherein only a single flow path of fluid occurs relative to the media in each separate compartment or certain flow paths can be combined within a single compartment such as counter current and cross flow. Suitable baffles and airlocks are provided to allow the flow. It is foreseen that for some configurations, a plurality of individual discrete sided compartments may not be required to properly direct the flows, but rather flow may be controlled in sectors or regions.

In accordance with the invention, it is foreseen that other regenerators are possible wherein the heated fluid from a drying process is joined with cool media from the drying process in order to heat or at least preheat the media for reuse in the drying process while recovering and reutilizing a significant amount of the heat used in the drying process.

It is foreseen that in some embodiments the fluid being exhausted from the regenerator may be used to slightly heat incoming material to be dried. For such a process the exhausted fluid would normally be mixed with a quantity of ambient air to prevent condensation on the incoming material.

It is foreseen that, when a heat pump is utilized to chill inlet air, either recycled or ambient in open looped systems, the energy removed may at least partially be utilized to heat material to be dried and/or media and thereby reduce energy consumption or increase capacity.

As used herein, the term stepwise, when used in conjunction with regenerator segments means that the fluid in the regenerator follows or passes through a sequence of segments one after another or stepwise wherein the flow path of the fluid in each segment can be at least partially concurrent, countercurrent, cross or mixed with respect to the path of the media. The overally general path of the fluid in the regenerator is normally countercurrent to the flow path of the media, but in each segments of the fluids stepwise progression through the regenerator, the path may assume the various different flow paths indicated. While progressing, the fluid passes through discrete segments that are regions that may be generally enclosed or open relative to adjacent regions or segments on either side thereof.

It is to be understood that while certain forms of the present invention have been illustrated and described herein, it is not to be limited to the specific forms or arrangement of parts described and shown.

What is claimed and desired to be secured by Letters Patent is as follows:

1. A drier apparatus for drying a material utilizing a media and a fluid comprising:
a) a drying chamber having first and second ends; said chamber being sized and shaped to operably receive the media in a heated state and the material to be dried near said first end and the fluid in a comparatively cool state near said second end and including fluid flow directing structure to flow the fluid in heat transfer relationship relative to the material such that the fluid becomes heated and at least partly saturated with moisture from the material;
c) a separator operably separating the media from the material as the material exits the drying chamber; and
d) a regenerator operably receiving media after passage of the media through the drying chamber and receiving heated fluid exiting the drying chamber; said regenerator including structure therein to pass the heated fluid in heat transfer relationship with said media so as to heat the media therein.

2. The drier apparatus according to claim 1 wherein:
a) said regenerator is configured to overall countercurrent flow the heated fluid relative to said media.

3. The drier apparatus according to claim 1 wherein:
a) said regenerator is configured to flow said heated fluid through said media by a flow selected from the group consisting of countercurrent, concurrent, cross and mixed flows and combinations thereof.

4. The drier apparatus according to claim 3 wherein:
a) said apparatus is configured so as to have incremental segments wherein said heated fluid flows through each of said segments in a flow selected from the group while overall generally flowing countercurrent to the media.

5. The drier apparatus according to claim 1 wherein:
a) said regenerator is configured to have incremental segments wherein said heated fluid flows cross flow through each segment but generally overall countercurrent flow relative to the media.

6. A method of drying a material comprising the steps of:
a) mixing the material to be dried with a heated media to form a heated mixture;
b) passing the mixture through a drying chamber;
c) flowing a fluid that is cooler than the heated mixture through the mixture as the mixture passes through the chamber such that the fluid exits the chamber hotter and wetter in comparison to entry of the fluid and the mixture exits the chamber cooler and drier in comparison to entry of the mixture into the chamber;
d) subsequent to the prior step separating the media and material;
e) reheating the media from the separator using the fluid from the chamber in a regenerator;
f) adding make up heat for heat lost in the method; and
g) thereafter returning media in a heated state to mix with the material to be dried.

7. The method according to claim 6 including:
a) mixing the media and material prior to entering the chamber.

8. The method according to claim 6 including:
a) mixing the media and material in the chamber.

9. The method according to claim 6 including the step of:
a) flowing the fluid through the media in the regenerator in a flow selected from countercurrent, concurrent, cross and mixed flows.

10. The method according to claim 6 including the step of:
a) flowing the fluid through the media in the regenerator in generally countercurrent flow.

11. The method according to claim 6 including the step of:
a) flowing the fluid through the media in the regenerator in generally cross flow.

12. The method according to claim 6 including the step of:
a) flowing the fluid through the media in the regenerator in incremental sections and in cross flow within each section and generally countercurrent to the overall general flow of the media.

13. A drier wherein a solid heated media is utilized to supply heat to a material to be dried in a drying chamber and then separated from the material in a cool state, including:
a) a regenerator operably receiving said material in the cool state and a heated fluid utilized to cool the material in a heated state; said regenerator including heat transfer structure to flow the heated fluid relative to the media in a flow selected from counter current flow, concurrent flow, cross flow, mixed flow and combinations thereof.

14. The drier according to claim 13 wherein:
a) said flow is stepwise.

15. The drier according to claim 14 wherein:
a) said fluid flows overall generally countercurrent to the flow of the media in the regenerator, but stepwise flows in incremental flows selected from the group consisting of counter current flow, concurrent flow, cross media flow, mixed flow and combinations thereof.

16. The drier according to claim 15 wherein:
a) said fluid flows stepwise in concurrent flow relative to said media.

17. The drier according to claim 15 wherein:
a) said fluid flows stepwise in cross media flow relative to said media.

18. The drier according to claim 15 wherein:
a) said fluid flows stepwise in mixed flow relative to said media.

19. A drying process wherein material to be dried is mixed with a media in a heated state and thereafter moisture is removed from the material by a fluid such that the media exits the drier in a cool state and the fluid in a hot state, including the step of:
a) flowing the media in the cool state and the fluid in the heated state together with each other in a flow selected from the group consisting of countercurrent flow, concurrent flow, cross flow, mixed flow and combinations thereof.

20. The process according to claim 19 including:
a) flowing said fluid generally overall countercurrent relative to the media within said regenerator.

21. The process according to claim 19 including:
a) flowing said in fluid cross flow relative to the media within said regenerator.

22. The process according to claim 19 including:
a) flowing said fluid in concurrent flow relative to the media within said regenerator.

23. The process according to claim 19 including:
a) flowing said fluid in mixed flow relative to the media within said regenerator.

24. The process according to claim 19 including:
a) flowing the fluid in said regenerator in stepwise increments through said media.

25. The process according to claim 24 including:
a) flowing said fluid in said stepwise increments in a flow selected from countercurrent, cross flow, concurrent and mixed flow while overall flowing the fluid in a flow selected from counter current, concurrent flow, cross media flow and mixed flow relative to the media throughout the entire regenerator.

26. The process according to claim 24 wherein:
a) the overall flow of the fluid relative to the media in the regenerator is countercurrent flow.
